(19) United States
(12) Patent Application Publication
(10) Pub. No.: US 2014/0182143 A1
(43) Pub. Date: Jul. 3, 2014

(54) VEGETATION CUTTER

(71) Applicant: MAKITA CORPORATION, Aichi (JP)

(72) Inventor: Yoshifumi MORITA, Aichi (JP)

(21) Appl. No.: 14/132,409

(22) Filed: Dec. 18, 2013

(30) Foreign Application Priority Data
Dec. 19, 2012 (JP) 2012-277051

(51) Int. Cl. A01D 34/412

(52) U.S. Cl. CPC A01D 34/412
USPC 30/276

(57) ABSTRACT

A vegetation cutter includes a frame rod assuming a pole and having a front end and a rear end; a cutter head mounted on the front end of the frame rod and including a rotary cutter and a drive motor connected to the rotary cutter; controller head mounted on the rear end of the frame rod and including a control circuit for controlling the drive motor; and a handle fixed to the frame rod to be held by hands of a user. The cutter head includes a cutter frame for enclosing the drive motor therein, rotatably supports the rotary cutter below the cutter frame and is connected to the frame rod. The cutter frame is comprised of a wall member formed with a plurality of ridgelike ribs projecting inward from a platelike member, each rib having a height between 0.5 mm and 10 mm.

### TECHNICAL FIELD

The present invention relates to a vegetation cutter such as a grass cutter, a lawn trimmer and a brush cutter, and more particularly to a vegetation cutter which comprises a frame rod, a cutter head mounted on the front end of the frame rod and including a rotary cutter and a drive motor connected to the rotary cutter, controller head mounted on the rear end of the frame rod and including a control circuit for controlling the rotary cutter and the drive motor, and a handle fixed to the frame rod to be held by hands of the user, in which the cutter head is arranged and configured to be manufactured in light weight and with sufficient robustness.

### BACKGROUND INFORMATION

A vegetation cutter is a kind of work apparatus for cutting grasses growing on a bank or in a park or in a lawn, and generally comprises a frame rod in the shape of a pole, a cutter head mounted on the front end of the frame rod and including a rotary cutter and a drive motor for rotating the rotary cutter, a controller head mounted on the rear end of the frame rod, and a handle fixed to the frame rod at a middle point thereon nearer to the rear end. When a user operates the vegetation cutter, the user holds the handle with his/her hands keeping the frame rod under his/her arm, and swings the cutter head right and left sweeping forward or backward on the grasses (along the ground) while the rotary cutter is rotating. The heavier the cutter head is at the front end of the frame rod, the harder the operation of the vegetation cutter would be, and the more the user would get tired. The cutter frame or the enclosure housing of the cutter head is generally made of metal which is a robust material in view of the possibility of cashing against obstacles on the ground such as stones and woods while cutting grasses, and therefore the cutter frame is apt to be heavy. Further in the case of a vegetation cutter comprising a cutter head which encloses a drive motor therein for rotating the rotary cutter, the weight of the drive motor accordingly increases the weight of the cutter head. While the cutter frame may be made of resin material (plastics) for a lighter weight, the thickness of the frame member should be retained to a certain extent to secure necessary robustness for use, which would be a bar to sufficiently decrease the weight.

### SUMMARY OF THE INVENTION

In view of the foregoing circumstances, therefore, it is a primary object of the present invention to provide a vegetation cutter, in which the decrease in weight of the cutter head is achieved while retaining the robustness of the cutter head against crashes.

According to the present invention, the object is accomplished by providing a vegetation cutter comprising: a frame rod assuming a shape of a pole, and having a front end and a rear end; a cutter head mounted on the front end of the frame rod and including a rotary cutter and a drive motor connected to the rotary cutter; a controller head mounted on the rear end of the frame rod and including a control circuit for controlling the drive motor; and a handle fixed to the frame rod to be held by hands of a user, wherein the cutter head includes a cutter frame for enclosing the drive motor therein, rotatably supports the rotary cutter below the cutter frame and is connected to the frame rod, and wherein the cutter frame is comprised of a wall member formed with a plurality of ridgelike ribs projecting inward from a platelike member, each rib having a height between 0.5 mm and 10 mm, each rib being apart from an adjacent rib by a pitch between 3 mm and 20 mm, and the ribs being provided in an area on the wall member, which area is 20% through 80% of a total area of the wall member of the cutter frame. The wall member of the cutter frame will thus retain robustness for enclosing the drive motor and holding the rotary cutter, while decreasing the weight of the cutter frame.

In an aspect of the present invention, the plurality of ribs may preferably be provided to cross each other in a grid pattern, having intersections in density of between 0.25 and 11.1 per square centimeter, thereby securing necessary robustness of the cutter frame for its weight.

In a further aspect of the present invention, the density of the intersections may preferably be between 0.69 and 4.0 per square centimeter, thereby securing necessary robustness of the cutter frame for its weight.

In a still further aspect of the present invention, the ribs may preferably be provided on the wall member of the cutter frame in an area covering a part which is connected to the frame rod through to a part just before where the drive motor is installed, and wherein the front end of the frame rod is pinched by and connected to the cutter frame at the part where the ribs are provided, thereby securing necessary robustness of the cutter frame for its weight.

In a still further aspect of the present invention, the thickness of the wall member where the ribs are provided and the thickness of the ribs may preferably be between 2 mm and 4 mm, thereby securing necessary robustness of the cutter frame for its weight.

In a still further aspect of the present invention, the pitch of the adjacent ribs is between 5 mm and 12 mm, thereby securing necessary robustness of the cutter frame for its weight.

In a still further aspect of the present invention, the cutter frame may preferably be made of fiberglass reinforced plastic, which is polycarbonate resin containing 30% of fiberglass, thereby securing necessary robustness of the cutter frame for its weight.

With the vegetation cutter configured as above, in which the cutter frame of the cutter head is comprised of a wall member formed with a plurality of ridgelike ribs projecting inward from a platelike member, and in which the height of the ribs, the distance between the adjacent ribs, the density of the intersections of the ribs, and the location and the percentage of the area where the ribs are provided out of the whole area of the wall member are properly selected, the decrease in weight and the robustness against crashes of the cutter head are achieved to provide a vegetation cutter suitable for working.

### BRIEF DESCRIPTION OF THE DRAWINGS

For a better understanding of the present invention, and to show how the same may be practiced and will work, reference will now be made, by way of example, to the accompanying drawings, in which:

FIG. 1 is an overall perspective view of an embodiment of a vegetation cutter according to the present invention;

FIG. 2 is a side elevational view of a right-half assembly of a cutter head as viewed from the inside of the otherwise whole assembly, where the cutter frame is manufactured by double-split molding; and

FIG. 3 is a cross sectional view of the cutter frame taken along the arrowed line A-A of FIG. 2.

### DETAILED DESCRIPTION OF EMBODIMENTS OF THE INVENTION

The invention and its embodiment can now be better understood by turning to the following detailed description of the preferred embodiment with reference to the accompanying drawings. The embodiment of the vegetation cutter hereunder described is of an electric motor-driven type.

It should be expressly understood that the illustrated embodiment is presented just as a practicable example of the invention and that the invention as defined by the claims may be broader than the illustrated embodiment described below. In the drawing, like reference characters refer to like parts so that repetitive explanations may be omitted.

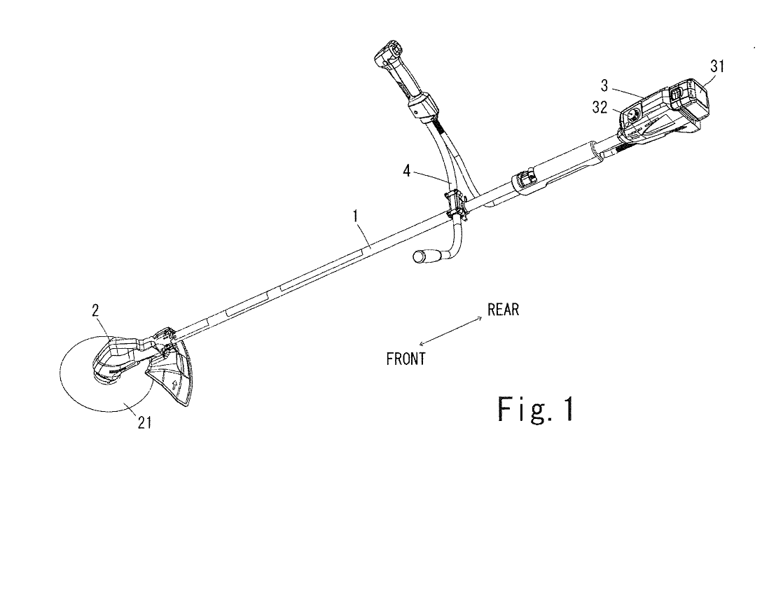

FIG. 1 illustrates an overall view of an embodiment of a vegetation cutter according to the present invention, in which on the front end of a frame rod 1 is mounted a cutter head 2, on the rear end of the frame rod 1 is mounted a controller head 3, and to the frame rod 1 at a middle point thereon nearer to the rear end is fixed a handle 4. The user of the vegetation cutter holds the handle 4 with his/her hands keeping the frame rod 1 under his/her arm, and swings the cutter head 2 right and left sweeping forward or backward on the grasses along the ground surface, thereby cutting the grasses by the rotating rotary cutter 21.

In the illustrated embodiment of the vegetation cutter according to the present invention, the cutter head 2 comprises a cutter frame for enclosing a drive motor and a reduction gear and for ratatably holding the rotary cutter 21 exposed outside below the cutter frame, and the controller head 3 carries a replaceable battery 31 and is provided with a control knob 32 for controlling a control circuit contained in the controller head 3 so as to controllably supply the electric power of the battery 31 to the drive motor in the cutter head 2, thereby operating the vegetation cutter under control.

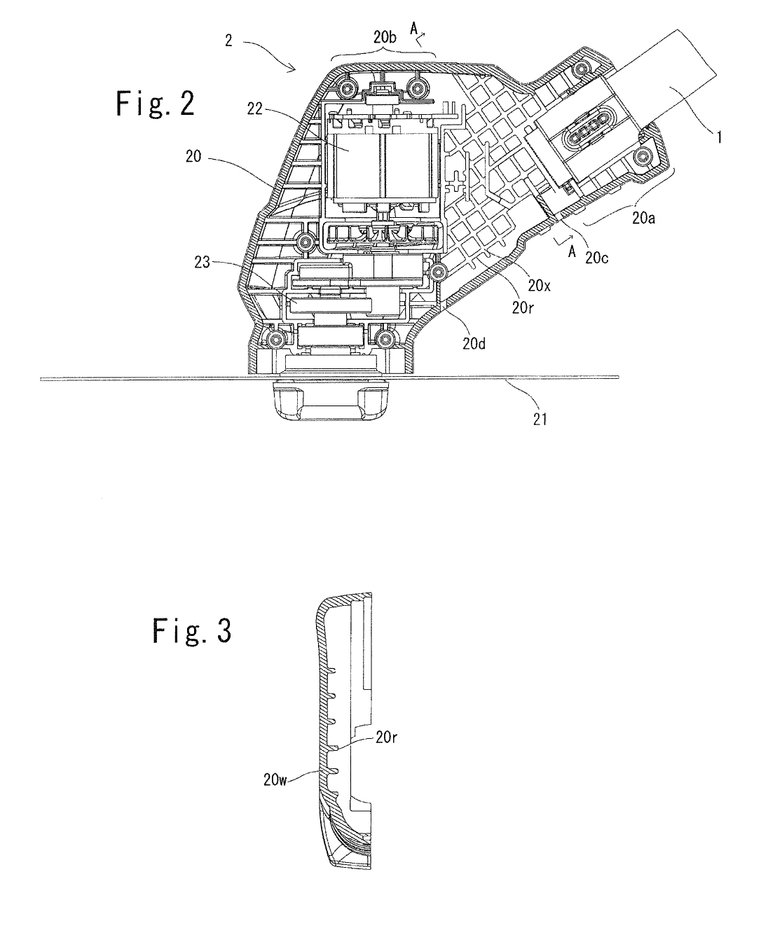

Turning now to FIG. 2 which illustrates a right-half assembly of the cutter head as viewed from the inside of the otherwise whole assembly, the cutter frame 20 of the cutter head 2 is manufactured from fiberglass reinforced polycarbonate resin containing 30% of fiberglass (PC-GF30) by double-split molding in the shape of an enclosure shell. As shown in FIG. 3, which is a cross sectional view of the cutter frame taken along the arrowed line A-A of FIG. 2, the cutter frame 20 is mainly made of a platelike wall member, and encloses the drive motor 22 and the reduction gear 23 and rotatably holds the rotary cutter 21 outside and below the cutter frame 20. The upper rear end portion (upper right-hand part in FIG. 2) of the cutter frame 20 is coupled to the front end portion of the frame rod 1. As shown in FIG. 3, the wall member 20w of the cutter frame 20 is integrally formed with a plurality of ridgelike ribs 20r projecting inward (rightward in FIG. 3) from the platelike member in the area covering the part 20a where the rod 1 is coupled and the part 20b where the drive motor 22 is accommodated.

The height of the ribs 20r will be determined as a compromise or trade-off between the crash-resistant robustness and the weight of the cutter frame 20, and will preferably be 0.5 mm and 10 mm. The rib 20r of the embodiment shown in FIG. 3 is 4 mm high and 2 mm thick. The thickness of the wall member 20w of the cutter frame 20 is preferably 2 to 4 mm, and is 3 mm with the illustrated embodiment. The distance between the adjacent ribs 20b is preferably 3 to 20 mm, and is more preferably between 5 to 12 mm, and is 7 mm with the illustrated embodiment. The ribs 20r are provided to cross each other in a grid pattern, and the number of intersections 20x is preferably selected to be between 0.25 to 11.1 per square centimeter. More preferably the number will be 0.69 to 4.0 per square centimeter, and the number in the illustrated embodiment is 2 per square centimeter. The part of the cutter frame at which the ribs 20r are provided is selected to be 20 to 80% of the inner surface area of the wall member of each half body of the cutter frame 20.

In addition, the cutter frame 20 is provided with a water escape or drainage hole 20c in the wall member 20w constituting the enclosure shell at the position below the area 20a where the rod 1 is coupled, and another water escape or drainage hole 20d in the wall member 20w constituting the enclosure shell at the position below the area 20b where the drive motor 22 is accommodated, so that the water which may get in after traveling along the rod 1 can drain out, lest the water should stay inside the cutter frame 20 and should damage the drive motor 22 or the reduction gear 23.

According to the present invention, the cutter frame of the cutter head of the vegetation cutter is comprised of a wall member which is integrally formed with a plurality of ridgelike ribs projecting inward from the platelike member in proper dimensions and proper density, which realizes a cutter head with a decreased weight and an increased robustness against crashing, which in turn makes the vegetation cutter durable while relieving the user of the apparatus from fatigue. The advantage will be particularly enjoyed when the cutter frame is formed of fiberglass reinforced plastic.

1. A vegetation cutter comprising:
a frame rod assuming a shape of a pole, and having a front end and a rear end;
a cutter head mounted on the front end of the frame rod and including a rotary cutter and a drive motor connected to the rotary cutter;
a controller head mounted on the rear end of the frame rod and including a control circuit for controlling the drive motor; and
a handle fixed to the frame rod to be held by hands of a user,
wherein the cutter head includes a cutter frame for enclosing the drive motor therein, rotatably supports the rotary cutter below the cutter frame and is connected to the frame rod, and
wherein the cutter frame is comprised of a wall member formed with a plurality of ridgelike ribs projecting inward from a platelike member, each rib having a height between 0.5 mm and 10 mm, each rib being apart from an adjacent rib by a pitch between 3 mm and 20 mm, and the ribs being provided in an area on the wall member, which area is 20% through 80% of a total area of the wall member of the cutter frame.

2. A vegetation cutter as claimed in claim 1, wherein the plurality of ribs are provided to cross each other in a grid pattern, having intersections in density of between 0.25 and 11.1 per square centimeter.

3. A vegetation cutter as claimed in claim 2, wherein the density of the intersections is between 0.69 and 4.0 per square centimeter.

4. A vegetation cutter as claimed in claim 1, wherein the ribs are provided on the wall member of the cutter frame in an area covering a part which is connected to the frame rod through to a part just before where the drive motor is installed, and wherein the front end of the frame rod is pinched by and connected to the cutter frame at the part where the ribs are provided.

5. A vegetation cutter as claimed in claim 1, wherein the thickness of the plate member where the ribs are provided and the thickness of the ribs are between 2 mm and 4 mm.

6. A vegetation cutter as claimed in claim 1, wherein the pitch of the adjacent ribs is between 5 mm and 12 mm.

7. A vegetation cutter as claimed in claim 1, wherein the cutter frame is made of fiberglass reinforced plastic, which is polycarbonate resin containing 30% of fiberglass.
